(19) United States
(12) Patent Application Publication
(10) Pub. No.: US 2023/0143648 A1
(43) Pub. Date: May 11, 2023

(54) METHOD AND APPARATUS FOR ENCODING/DECODING IMAGE, ON BASIS OF AVAILABLE SLICE TYPE INFORMATION FOR GDR OR IRAP PICTURE, AND RECORDING MEDIUM STORING BITSTREAM

(71) Applicant: LG ELECTRONICS INC., Seoul (KR)

(72) Inventors: Jung Hak NAM, Seoul (KR); Hendry HENDRY, Seoul (KR); Hyeong Moon JANG, Seoul (KR); Seung Hwan KIM, Seoul (KR)

(21) Appl. No.: 17/916,724

(22) PCT Filed: Apr. 5, 2021
(86) PCT No.: PCT/KR2021/004224

§ 371 Date: Oct. 3, 2022

Related U.S. Application Data
(60) Provisional application No. 63/004,572, filed on Apr. 3, 2020.

(51) Int. Cl. H04N 19/159; H04N 19/176; H04N 19/174

(52) U.S. Cl. CPC H04N 19/159; H04N 19/176; H04N 19/174

(57) ABSTRACT

An image encoding/decoding method and apparatus are provided. An image decoding method may comprise determining whether an inter slice type is allowed for a current picture including a current block, determining whether an intra slice type is allowed for the current picture, based on the inter slice type being allowed for the current picture, and decoding the current block based on a slice type allowed for the current picture. Whether the inter slice type is allowed for the current picture may be determined based on a picture type of the current picture and whether a current layer including the current picture is able to use inter-layer prediction.

### TECHNICAL FIELD

The present disclosure relates to an image encoding/decoding method and apparatus, and, more particularly, to an image encoding/decoding method and apparatus based on information on an available slice type for a GDR or IRAP picture, and a recording medium for storing bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus based on information on an available slice type for a GDR or IRAP picture.

Another object of the present disclosure is to provide an image encoding/decoding method and apparatus for skipping signaling of reference picture list information for an IRAP picture.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

Another object of the present disclosure is to provide method of transmitting a bitstream generated by an image encoding method or apparatus according to the present disclosure.

The technical problems solved by the present disclosure are not limited to the above technical problems and other technical problems which are not described herein will become apparent to those skilled in the art from the following description.

### Technical Solution

An image decoding method according to an aspect of the present disclosure comprises determining whether an inter slice type is allowed for a current picture including a current block, determining whether an intra slice type is allowed for the current picture, based on the inter slice type being allowed for the current picture, and decoding the current block based on a slice type allowed for the current picture. Whether the inter slice type is allowed for the current picture may be determined based on a picture type of the current picture and whether a current layer including the current picture is able to use inter-layer prediction.

An image decoding apparatus according to an aspect of the present disclosure comprises a memory and at least one processor. The at least one processor may determine whether an inter slice type is allowed for a current picture including a current block, determine whether an intra slice type is allowed for the current picture, based on the inter slice type being allowed for the current picture, and decode the current block based on a slice type allowed for the current picture. Whether the inter slice type is allowed for the current picture may be determined based on a picture type of the current picture and whether a current layer including the current picture is able to use inter-layer prediction.

An image encoding method according to another aspect of the present disclosure comprises encoding first information on whether an inter slice type is allowed for a current picture including a current block and encoding second information on whether an intra slice type is allowed for the current picture, based on the inter slice type being allowed for the current picture. Whether the inter slice type is allowed for the current picture may be determined based on a picture type of the current picture and whether a current layer including the current picture is able to use inter-layer prediction.

In addition, a computer-readable recording medium according to another aspect of the present disclosure may store the bitstream generated by the image encoding apparatus or the image encoding method of the present disclosure.

In a transmission method according to another aspect of the present disclosure, a bitstream generated by an image encoding method or an image encoding apparatus of the present disclosure may be transmitted.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

According to the present disclosure, it is possible to provide an image encoding/decoding method and apparatus based on information on an available slice type for a GDR or IRAP picture.

According to the present disclosure, it is possible to provide an image encoding/decoding method and apparatus for skipping signaling of reference picture list information for an IRAP picture.

Also, according to the present disclosure, it is possible to provide a recording medium storing a bitstream generated by an image encoding method or apparatus according to the present disclosure.

Also, according to the present disclosure, it is possible to provide a recording medium storing a bitstream received, decoded and used to reconstruct an image by an image decoding apparatus according to the present disclosure.

Also, according to the present disclosure, it is possible to provide a method of transmitting a bitstream generated by an image encoding method or apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus, to which an embodiment of the present disclosure is applicable.

FIG. 4 is a view illustrating an example of a layer structure for a coded image/video.

FIG. 5 is a view illustrating an example of a picture header.

FIG. 6 is a view illustrating an example of a slice header.

FIG. 7 is a view illustrating a picture header according to an embodiment of the present disclosure.

FIGS. 8 to 9 are views illustrating a picture header including idr_pic_flag according to an embodiment of the present disclosure.

FIGS. 10 to 16 are views illustrating a picture header according to an embodiment of the present disclosure.

FIG. 17 is a flowchart illustrating an image encoding method according to an embodiment of the present disclosure.

FIG. 18 is a flowchart illustrating an image decoding method according to an embodiment of the present disclosure.

FIG. 19 is a view illustrating a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

Overview of Video Coding System

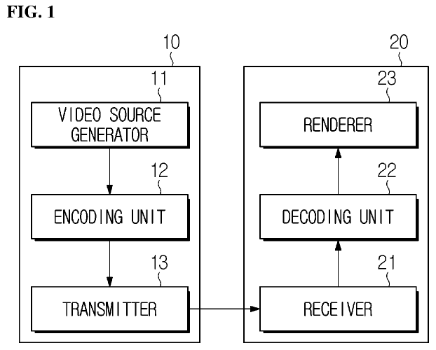

FIG. 1 is a view illustrating a video coding system, to which an embodiment of the present disclosure is applicable.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

Overview of Image Encoding Apparatus

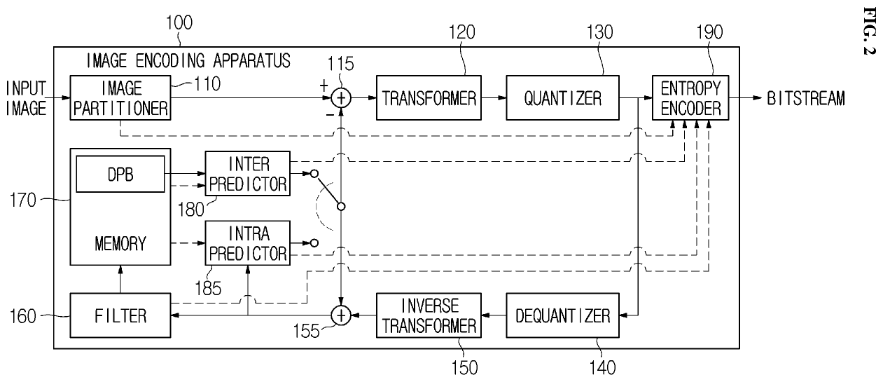

FIG. 2 is a view schematically illustrating an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loeve transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

Overview of Image Decoding Apparatus

FIG. 3 is a view schematically illustrating an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “predictor”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

### Example of Coding Layer Structure

A coded video/image according to the present disclosure may be processed, for example, according to a coding layer and structure which will be described below.

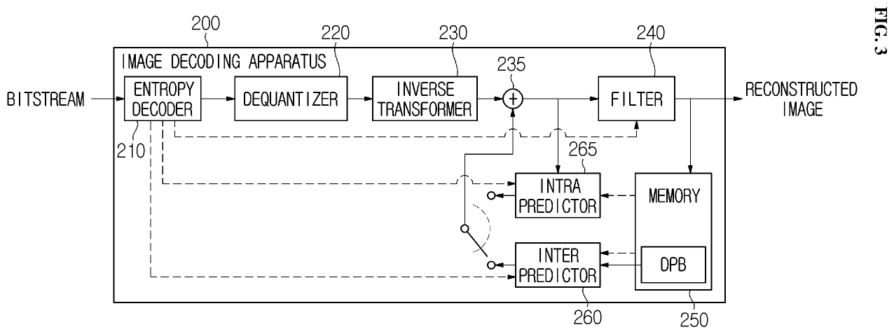

FIG. 4 is a view illustrating an example of a layer structure for a coded image/video.

The coded image/video is classified into a video coding layer (VCL) for an image/video decoding process and handling itself, a lower system for transmitting and storing encoded information, and a network abstraction layer (NAL) present between the VCL and the lower system and responsible for a network adaptation function.

In the VCL, VCL data including compressed image data (slice data) may be generated or a supplemental enhancement information (SEI) message additionally required for a decoding process of an image or a parameter set including information such as a picture parameter set (PPS), a sequence parameter set (SPS) or a video parameter set (VPS) may be generated.

In the NAL, header information (NAL unit header) may be added to a raw byte sequence payload (RBSP) generated in the VCL to generate a NAL unit. In this case, the RBSP refers to slice data, a parameter set, an SEI message generated in the VCL. The NAL unit header may include NAL unit type information specified according to RBSP data included in a corresponding NAL unit.

As shown in FIG. 4, the NAL unit may be classified into a VCL NAL unit and a non-VCL NAL unit according to the type of the RBSP generated in the VCL. The VCL NAL unit may mean a NAL unit including information on an image (slice data), and the Non-VCL NAL unit may mean a NAL unit including information (parameter set or SEI message) required to decode an image.

The VCL NAL unit and the Non-VCL NAL unit may be attached with header information and transmitted through a network according to the data standard of the lower system. For example, the NAL unit may be modified into a data format of a predetermined standard, such as H.266/VVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signaled. For example, this may be largely classified into a VCL NAL unit type and a non-VCL NAL unit type depending on whether the NAL unit includes information on an image (slice data). The VCL NAL unit type may be classified according to the property and type of the picture included in the VCL NAL unit, and the Non-VCL NAL unit type may be classified according to the type of a parameter set.

An example of the NAL unit type specified according to the type of the parameter set/information included in the Non-VCL NAL unit type will be listed below.
DCI (Decoding capability information) NAL unit type (NUT): Type for NAL unit including DCI
VPS(Video Parameter Set) NUT: Type for NAL unit including VPS
SPS(Sequence Parameter Set) NUT: Type for NAL unit including SPS
PPS (Picture Parameter Set) NUT: Type for NAL unit including PPS
APS (Adaptation Parameter Set) NUT: Type for NAL unit including APS
PH (Picture header) NUT: Type for NAL unit including a picture header

The above-described NAL unit types may have syntax information for a NAL unit type, and the syntax information may be stored in a NAL unit header and signaled. For example, the syntax information may be nal_unit_type, and the NAL unit types may be specified using nal_unit_type values.

Meanwhile, one picture may include a plurality of slices, and one slice may include a slice header and slice data. In this case, one picture header may be further added to a plurality of slices (slice header and slice data set) in one picture. The picture header (picture header syntax) may include information/parameters commonly applicable to the picture. The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may information/parameters commonly applicable to multiple layers. The DCI (DCI syntax) may include information/parameters related to decoding capability.

In the present disclosure, a high level syntax (HLS) may include at least one of the APS syntax, the PPS syntax, the SPS syntax, the VPS syntax, the DCI syntax, the picture header syntax or the slice header syntax. In addition, in the present disclosure, a low level syntax (LLS) may include, for example, a slice data syntax, a CTU syntax, a coding unit syntax, a transform unit syntax, etc.

In the present disclosure, image/video information encoded in the encoding apparatus and signaled to the decoding apparatus in the form of a bitstream may include not only in-picture partitioning related information, intra/inter prediction information, residual information, in-loop filtering information but also information on the slice header, information on the picture header, information on the APS, information on the PPS, information on the SPS, information on the VPS and/or information on the DCI. In addition, the image/video information may further include general constraint information and/or information on a NAL unit header.

### Example of NAL Unit Type

In general, one NAL unit type may be set for one picture. As described above, syntax information indicating a NAL unit type may be stored in the NAL unit header of a NAL unit and signaled. For example, the syntax information may be nal_unit_type, and NAL unit types may be specified using an nal_unit_type value. An example of NAL unit types is shown in Table 1 below.

TABLE 1

| | Name of | Content of NAL unit and | NAL unit |
|---|---|---|---|
| nal_unit_type | nal_unit_type | RBSP syntax structure | type class |
| 0 | TRAIL_NUT | Coded slice of a trailing picture | VCL |
| | | slice_layer_rbsp( ) | |
| 1 | STSA_NUT | Coded slice of an STSA picture | VCL |
| | | slice_layer_rbsp( ) | |
| 2 | RADL_NUT | Coded slice of a RADL picture | VCL |
| | | slice_layer_rbsp( ) | |
| 3 | RASL_NUT | Coded slice of a RASL picture | VCL |
| | | slice_layer_rbsp( ) | |
| 4 . . . 6 | RSV_VCL_4 . . . | Reserved non-IRAP | VCL |
| | RSV_VCL_6 | VCL NAL unit types | |
| 7 | IDR_W_RADL | Coded slice of an IDR picture | VCL |
| 8 | IDR_N_LP | slice_layer_rbsp( ) | |
| 9 | CRA_NUT | Coded slice of a CRA picture | VCL |
| | | silce_layer_rbsp( ) | |
| 10 | GDR_NUT | Coded slice of a GDR picture | VCL |
| | | slice_layer_rbsp( ) | |
| 11 | RSV_IRAP_11 | Reserved IRAP | VCL |
| 12 | RSV_IRAP_12 | VCL NAL unit types | |
| 13 | DCI_NUT | Decoding capability information | non-VCL |
| | | decoding_capability_information_rbsp( ) | |
| 14 | VPS_NUT | Video parameter set | non-VCL |
| | | video_parameter_set_rbsp( ) | |
| 15 | SPS_NUT | Sequence parameter set | non-VCL |
| | | seq_parameter_set_rbsp( ) | |
| 16 | PPS_NUT | Picture parameter set | non-VCL |
| | | pic_parameter_set_rbsp( ) | |
| 17 | PREFIX_APS_NUT | Adaptation parameter set | non-VCL |
| 18 | SUFFIX_APS_NUT | adaptation_parameter_set_rbsp( ) | |
| 19 | PH_NUT | Picture header | non-VCL |
| | | picture_header_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

NUT: NAL unit type
STSA: Step-wise Temporal sub-layer Switching Access
RADL: Random Access Decodable Leading
RASL: Random Access Skipped Leading
IDR: Instantaneous Decoding Refresh
LP: Leading Picture
_W_RADL: With RADL
_N_LP: No LP, without LP
CRA: Clean Random Access
GDR: Gradual Decoding Refresh
- IRAP: Intra Random Access Point

Referring to Table 1, a VCL NAL unit type may be classified into NAL unit types #0 to #12 according to the picture type. In addition, a non-VCL NAL unit type may be classified into NAL unit types #13 to #31 according to the parameter type. The VCL NAL unit types are summarized by picture type as follows.

(1)) IRAP (Intra Random Access Point) Picture

An IRAP picture is a picture which may be accessed randomly and may mean a picture having the same NAL unit type in a range of IDR_W_RADL to CRA_NUT. The IRAP picture may include an instantaneous decoding refresh (IDR) picture and a clean random access (CRA) picture. The IRAP picture may not use inter prediction based on a reference picture in the same layer in a decoding process. A first picture in a bitstream in a decoding order may be an IRAP picture or a gradual decoding refresh (GDR) picture. For a single-layer bitstream, when parameter sets which need to be referenced are available, even if no picture preceding the IRAP picture in a decoding order is decoded, all non-random access skipped leading (RASL) pictures following the IRAP picture in a decoding order in the IRAP picture and a coded layer video sequence (CLVS) may be correctly decoded.

(2) CRA (Clean Random Access) Picture

A CRA picture mean an IRAP picture in which each VCL NAL unit has a NAL unit type such as CRA_NUT. The CRA picture may not use inter prediction in a decoding process. The CRA picture may be a first picture in a bitstream in a decoding order or a picture after the first picture. The CRA picture may be associated with RADL or RASL pictures. When NoOutputBeforeRecoveryFlag has a first value (e.g., 1) for a CRA picture, RASL pictures associated with the CRA picture may not be decoded since reference pictures which are not present in a bitstream are referenced and, as a result, may not be output by an image decoding apparatus. Here, NoOutputBeforeRecoveryFlag may specify whether pictures preceding a recovery point picture in a decoding order are output before the recovery point picture. For example, NoOutputBeforeRecoveryFlag having a first value (e.g., 1) may specify that the pictures preceding the recovery point picture in a decoding order are not output before the recovery point picture. In this case, the CRA picture may be a first picture in a bitstream or a first picture following an end of sequence (EOS) NAL unit in a decoding order, which may mean that random access occurs. In contrast, NoOutputBeforeRecoveryFlag having a second value (e.g., 0) may specify that the pictures preceding the recovery point picture in a decoding order may be output before the recovery point picture. In this case, the CRA picture may not be a first picture in a bitstream or a first picture following an end of sequence (EOS) NAL unit in a decoding order, which may mean that random access does not occur.

(3) IDR (Instantaneous Decoding Refresh) Picture

An IDR picture may mean an IRAP picture in which each VCL NAL unit has a NAL unit type such as IDR_W_RADL or IDR_N_LP. The IDR picture may not use inter prediction in a decoding process. The IDR picture may be a first picture in a bitstream in a decoding order or may be a picture after the first picture. Each IDR picture may be a first picture of a CVS (Coded Video Sequence) in a decoding order. When each VCL NAL unit for the IDR picture has a NAL unit type such as IDR_W_RADL, the IDR picture may have associated RADL pictures. In contrast, when each VCL NAL for an IDR picture has a NAL unit type such as IDR_N_LP, the IDR picture may not have associated leading pictures. Meanwhile, an IDR picture may not have associated RASL pictures.

(4) RADL (Random Access Decodable Leading) Picture

A RADL picture may mean a picture in which each VCL NAL unit has a NAL unit type such as RADL_NUT. All RADL pictures may be leading pictures.

### (5) RASL (Random Access Skipped Leading) Picture

A RASL picture may mean a picture in which at least one VCL NAL unit has a NAL unit type such as RASL_NUT and the remaining VCL NAL units have a NAL unit type such as RASL_NUT or RADL_NUT. All RASL pictures may be leading pictures of an associated CRA picture.

(6) Trailing Picture

A trailing picture may mean a picture in which each VCL NAL unit has a NAL unit type such as TRAIL_NUT. Trailing pictures associated with an IRAP or GDR picture may follow the IRAP or GDR picture in a decoding order. Pictures following an associated IRAP in an output order and preceding the associated IRAP picture in a decoding order may not be allowed.

(7) GDR (Gradual Decoding Refresh) Picture

A GDR picture is a picture which may be accessed randomly, and may mean a picture in which each VCL NAL unit has a NAL unit type such as GDR_NUT.

A GDR feature may mean that decoding starts from a picture in which all parts of a reconstructed picture may not be correctly decoded but a correctly decoded part of the reconstructed picture within a picture (subsequence picture) following the picture gradually increases until the whole picture is correctly decoded. In this case, a picture in which a decoding process may start with a GDR feature is referred to as a GDR picture and a first picture after the GDR picture in which the whole picture is correctly decoded is referred to as a recovery point picture.

(8) STSA (Step-Wise Temporal Sublayer Access) Picture

An STSA picture is a picture which may be accessed randomly, and may mean a picture in which each VCL NAL unit has a NAL unit type such as STSA_NUT.

High Level Syntax

As described above, for image/video coding, high level syntax (HLS) may be encoded/signaled Image/video information may include HLS, and an image/video coding method may be performed based on the image/video information.

As an example of the image/video information, reference picture list information (e.g., ref_pic_lists) may be signaled in a picture header or a slice header, based on rpl_info_in_ph_flag syntax signaled in a picture parameter set. Here, rpl_info_in_ph_flag may specify whether reference picture list information is present in a picture header. For example, rpl_info_in_ph_flag of a first value (e.g., 1) may specify that reference picture list information is present in a picture header and is not present in a slice header. In contrast, rpl_info_in_ph_flag of a second value (e.g., 0) may specify that reference picture list information is not present in a picture header and may be present in a slice header.

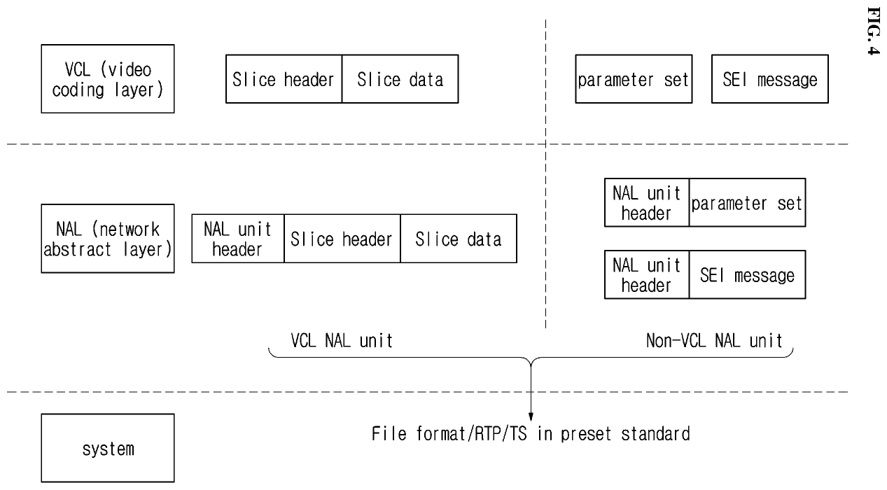

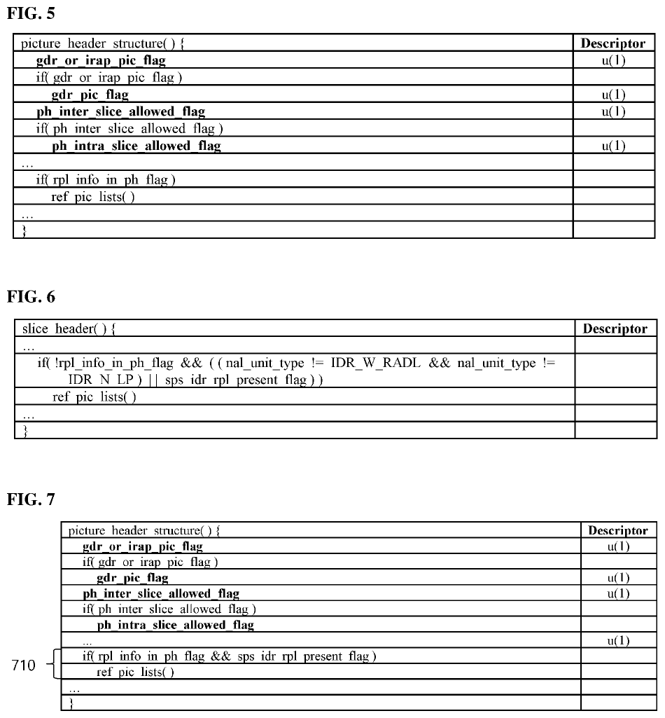

FIG. 5 is a view illustrating an example of a picture header.

Referring to FIG. 5, a picture header may include a syntax element gdr_or_irap_pic_flag. gdr_or_irap_pic_flag may specify whether a current picture is a GDR (Gradual Decoding Refresh) or IRAP (Intra Random Access Point) picture. For example, gdr_or_irap_pic_flag of a first value (e.g., 1) may specify that the current picture is a GDR or IRAP picture. In contrast, gdr_or_irap_pic_flag of a second value (e.g., 0) may specify that the current picture is not a GDR picture and may be an IRAP picture.

In addition, a picture header may include a syntax element gdr_pic_flag. gdr_pic_flag may specify whether the current picture is a GDR picture. For example, gdr_pic_flag of a first value (e.g., 1) may specify that the current picture is a GDR picture. In contrast, gdr_pic_flag of a second value (e.g., 0) may specify that the current picture is not a GDR picture. When gdr_pic_flag is not present (that is, is not signaled), the value of gdr_pic_flag may be inferred as a second value (e.g., 0). When the GDR picture is not available and is not present in a CLVS (coded layer video sequence) (e.g., sps_gdr_enabled_flag==0), the value of gdr_pic_flag may be limited to a second value (e.g., 0). Meanwhile, when gdr_or_irap_pic_flag has a first value (e.g., 1) and gdr_pic_flag has a second value (e.g., 0), the current picture may be determined to be an IRAP picture.

In addition, a picture header may include a syntax element ph_inter_slice_allowed_flag. ph_inter_slice_allowed_flag may specify whether one or more slices in a current picture may have an inter slice type (e.g., B slice type or P slice type). For example, ph_inter_slice_allowed_flag of a first value (e.g., 1) may specify that one or more coded slices having a B slice type (i.e., sh_slice_type=0) or a P slice type (i.e., sh_slice_type=1) may be present in a current picture. In contrast, ph_inter_slice_allowed_flag of a second value (e.g., 0) may specify that all coded slices in the current picture have an I slice type (i.e., sh_slice_type=2).

In addition, a picture header may include a syntax element ph_intra_slice_allowed_flag. ph_intra_slice_allowed_flag may specify whether one or more slices in the current picture may have an intra slice type (e.g., I slice type). For example, ph_intra_slice_allowed_flag of a first value (e.g., 1) may specify that one or more coded slices having an I slice type (i.e., sh_slice_type=2) may be present in the current picture. In contrast, ph_intra_slice_allowed_flag of a second value (e.g., 0) may specify that all coded slices in the current picture have a B slice type (i.e., sh_slice_type=0) or a P slice type (i.e., sh_slice_type=1). ph_intra_slice_allowed_flag may be signaled only when ph_intra_slice_allowed_flag has a first value (e.g., 1). When ph_intra_slice_allowed_flag is not present, the value of ph_intra_slice_allowed_flag may be inferred as a first value (e.g., 1).

Meanwhile, when the above-described rpl_info_in_ph_flag has a first value (e.g., 1), reference picture list information ref_pic_lists may be signaled in a picture header.

As described above, the picture header may include two syntax elements (e.g., ph_inter_slice_allowed_flag and ph_intra_slice_allowed_flag) specifying whether signaling of syntax elements for inter-predicted slices and intra-predicted slices is allowed in the picture header. However, since a GDR picture includes one or more slices having an inter slice type by virtue of the picture attributes, ph_inter_slice_allowed_flag may not be signaled for the GDR picture. However, in the picture header of FIG. 5, since ph_inter_slice_allowed_flag is signaled unconditionally, a problem of unnecessarily increasing signaling overhead occurs.

FIG. 6 is a view illustrating an example of a slice header.

Referring to FIG. 6, when rpl_info_in_ph_flag has a second value (e.g., 0), reference picture list information ref_pic_lists may be signaled in a slice header under a predetermined condition. Specifically, when rpl_info_in_ph_flag has a second value (e.g., 0), a NAL unit type is not IDR_W_RADL and IDR_N_LP (i.e., nal_unit_type !=IDR_W_RADL && nal_unit_type !=IDR_N_LP), or sps_idr_rpl_present_flag has a first value (e.g., 1), ref_pic_lists may be signaled. Here, sps_idr_rpl_present_flag of a first value (e.g., 1) may specify that syntax elements regarding a reference picture list may be present in slice headers of slices having a NAL unit type such as IDR_W_RADL or IDR_N_LP.

In general, in case of an IDR picture having a NAL unit type such as IDR_W_RADL or IDR_N_LP, reference picture list information is unnecessary by virtue of the picture attributes. Accordingly, in order to signal reference picture list information ref_pic_list, it is necessary to check a nal_unit_type value which is information on a NAL unit type signaled in a NAL unit header. Meanwhile, even if nal_unit_type has a value related to an IDR picture, in case of a bitstream extraction and merging scenario, reference picture list information may be required. Accordingly, in order to signal reference picture list information ref_pic_list, it is necessary to check sps_idr_rpl_present_flag specifying whether syntax elements regarding a reference picture list is present in a slice header.

However, in a picture header, reference picture list information is signaled without considering the above-described additional signaling conditions. That is, in the picture header, reference picture list information ref_pic_list is signaled only based on rpl_info_in_ph_flag. Therefore, even for an IDR picture which does not accompany bitstream extraction and merging, a problem that reference picture list information ref_pic_list may be unnecessarily signaled occurs.

In order to solve the above-described problems, a signaling condition of reference picture list information may be added or a flag specifying that a current picture is an IDR picture may be added to a picture header. Alternatively, a signaling condition of syntax elements related to an inter slice may be added to the picture header. Hereinafter, embodiments of the present disclosure will be described in detail with reference to the accompanying drawings.

### Embodiment 1

According to Embodiment 1 of the present disclosure, in a picture header, reference picture list information may be signaled based on whether syntax elements regarding a reference picture list of an IDR picture are present in a slice header (i.e., sps_idr_rpl_present_flag).

FIG. 7 is a view illustrating a picture header according to an embodiment of the present disclosure.

Referring to FIG. 7, a picture header may include a syntax element gdr_or_irap_pic_flag specifying whether a current picture is a GDR (Gradual Decoding Refresh) or an IRAP (Intra Random Access Point) picture and a syntax element gdr_pic_flag specifying whether a current picture is a GDR picture. In addition, the picture header may include a syntax element ph_inter_slice_allowed_flag specifying whether one or more slices in the current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In the picture header, reference picture list information ref_pic_lists may be signaled based on a predetermined first condition (710). Specifically, ref_pic_lists may be signaled only when reference picture list information is in the picture header (i.e., rpl_info_in_ph_flag==1) and syntax elements regarding a reference picture list are present in slice headers of slices having a NAL unit type such as IDR_N_LP or IDR_W_RADL. Here, IDR_N_LP may mean a NAL unit type of an IDR picture which does not have an associated leading picture (e.g., RASL and RADL picture) in a bitstream. In addition, IDR_W_RADL may mean a NAL unit type of an IDR picture which does not have an associated RASL picture in a bitstream but may have an associated RADL picture.

The case of FIG. 7 may be different from the picture header of FIG. 5, in that reference picture list information ref_pic_lists is signaled, based on whether sps_idr_rpl_present_flag has a first value (e.g., 1). That is, when syntax elements regarding a reference picture list are not present in a slice header (i.e., sps_idr_rpl_present_flag==0), ref_pic_lists may not be signaled in a picture header. Therefore, a problem that reference picture list information of the IDR picture is unnecessarily signaled in the picture header may be solved.

### Embodiment 2

According to Embodiment 2 of the present disclosure, a syntax element specifying whether a current picture is an IDR picture may be newly defined in a picture header.

FIG. 8 is a view illustrating a picture header including idr_pic_flag according to an embodiment of the present disclosure.

Referring to FIG. 8, a picture header may include a syntax element gdr_or_irap_pic_flag specifying whether a current picture is a GDR or IRAP picture and a syntax element gdr_pic_flag specifying whether a current picture is a GDR picture. In addition, the picture header may include a syntax element ph_inter_slice_allowed_flag specifying whether one or more slices in the current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In addition, the picture header may further include a syntax element idr_pic_flag (810). idr_pic_flag may specify whether the current picture is an IDR picture. For example, idr_pic_flag of a first value (e.g., 1) may specify that the current picture is an IDR picture. In contrast, idr_pic_flag of a second value (e.g., 0) may specify that the current picture is not an IDR picture. When idr_pic_flag is not present, idr_pic_flag may be inferred to as a second value (e.g., 0).

idr_pic_flag may be conditionally signaled based on gdr_or_irap_pic_flag. For example, when gdr_or_irap_pic_flag has a first value (e.g., 1) specifying that the current picture is a GDR or IRAP picture, idr_pic_flag may be signaled. In contrast, when gdr_or_irap_pic_flag has a second value (e.g., 0) specifying that the current picture is not a GDR picture and may be an IRAP picture, idr_pic_flag may not be signaled. In this way, idr_pic_flag may be signaled under the same condition (i.e., gdr_or_irap_pic_flag==1) as gdr_pic_flag.

Meanwhile, in another embodiment, idr_pic_flag may be conditionally signaled based on gdr_or_irap_pic_flag and gdr_pic_flag.

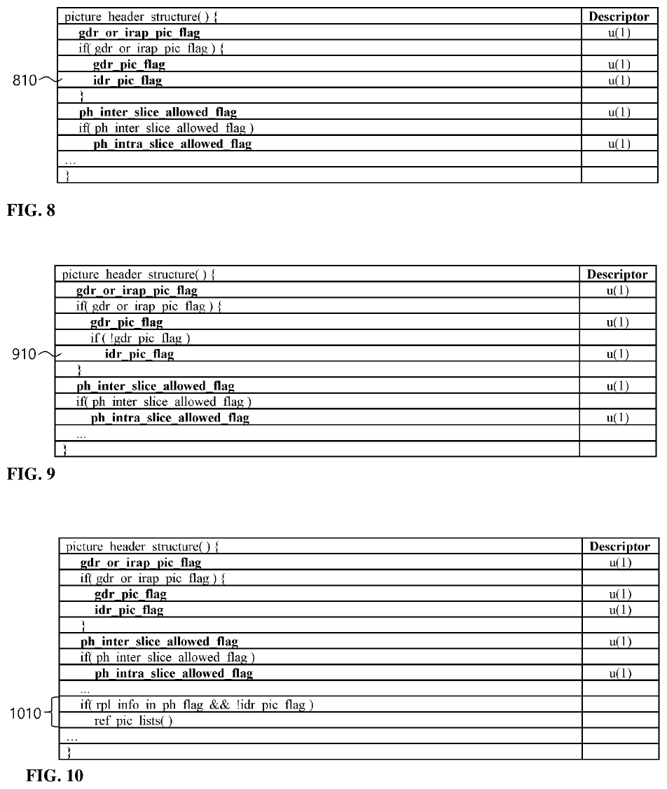

FIG. 9 is a view illustrating a picture header including idr_pic_flag according to another embodiment of the present disclosure.

Referring to FIG. 9, a picture header may include a syntax element gdr_or_irap_pic_flag specifying whether a current picture is a GDR or IRAP picture and a syntax element gdr_pic_flag specifying whether a current picture is a GDR picture. In addition, the picture header may include a syntax element ph_inter_slice_allowed_flag specifying whether one or more slices in a current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In addition, the picture header may further include a syntax element idr_pic_flag specifying whether a current picture is an IDR picture (910). The semantics of idr_pic_flag were described above with reference to FIG. 8.

idr_pic_flag may be conditionally signaled based on gdr_or_irap_pic_flag and gdr_pic_flag. For example, when gdr_or_irap_pic_flag has a first value (e.g., 1) specifying that a current picture is a GDR or IRAP picture and gdr_pic_flag has a second value (e.g., 0) specifying that a current picture is not a GDR picture, idr_pic_flag may be signaled. In contrast, when gdr_or_irap_pic_flag has a second value (e.g., 0) specifying that a current picture is not a GDR picture and may be an IRAP picture or gdr_or_irap_pic_flag has a first value (e.g., 1) specifying that a current picture is a GDR picture, idr_pic_flag may not be signaled. Therefore, idr_pic_flag may be signaled only when the current picture is an IRAP picture.

Therefore, as idr_pic_flag specifying that the current picture is an IDR picture is explicitly signaled, the signaling condition of various syntax elements on the premise that the current picture is an IDR picture may be simplified.

### Embodiment 3

According to Embodiment 3 of the present disclosure, in a picture header, reference picture list information may be signaled based on whether a current picture is an IDR picture.

FIG. 10 is a view illustrating a picture header according to an embodiment of the present disclosure.

Referring to FIG. 10, a picture header may include a syntax element gdr_or_irap_pic_flag specifying whether a current picture is a GDR or IRAP picture and a syntax element gdr_pic_flag specifying whether a current picture is a GDR picture. In addition, the picture header may include a syntax element ph_inter_slice_allowed_flag specifying whether one or more slices in a current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In an embodiment, when gdr_or_irap_pic_flag has a first value (e.g., 1), gdr_pic_flag has a second value (e.g., 0) (that is, a current picture is an IRAP picture), and vps_independent_layer_flag[GeneralLayerIdx[nuh_layer_id] ] has a first value (e.g., 1), the value of ph_inter_slice_allowed_flag may be set to a second value (e.g., 0). Here, vps_independent_layer_flag[GeneralLayerIdx[nuh_layer_id] ] of a first value (e.g., 1) may specify that a layer having an index GeneralLayerIdx[nuh_layer_id] does not use inter-layer prediction.

In addition, the picture header may further include a syntax element idr_pic_flag specifying whether a current picture is an IDR picture. The semantics and signaling condition of idr_pic_flag were described above with reference to FIG. 8.

In the picture header, reference picture list information ref_pic_lists may be signaled based on a predetermined second condition (1010). Specifically, ref_pic_lists may be signaled only when reference picture list information is present in the picture header (i.e., rpl_info_in_ph_flag==1) and the current picture is not an IDR picture (i.e., idr_pic_flag==0).

The case of FIG. 10 may be different from the picture header of FIG. 5, in that reference picture list information ref_pic_lists is signaled, based on whether the current picture is an IDR picture. That is, when the current picture is an IDR picture (i.e., idr_pic_flag==1), ref_pic_lists may not be signaled in a picture header. Therefore, a problem that reference picture list information of the IDR picture is unnecessarily signaled in the picture header may be solved.

### Embodiment 4

According to Embodiment 4 of the present disclosure, in a picture header, reference picture list information may be signaled based on whether a current picture is an IDR picture and whether syntax elements regarding a reference picture list of an IDR picture is present in a slice header.

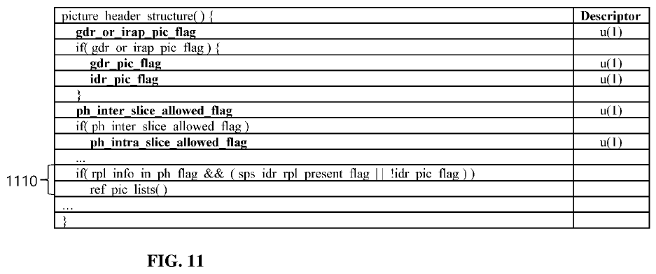

FIG. 11 is a view illustrating a picture header according to an embodiment of the present disclosure.

Referring to FIG. 11, a picture header may include a syntax element gdr_or_irap_pic_flag specifying whether a current picture is a GDR or IRAP picture and a syntax element gdr_pic_flag specifying whether a current picture is a GDR picture. In addition, the picture header may include a syntax element ph_inter_slice_allowed_flag specifying whether one or more slices in a current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In an embodiment, when gdr_or_irap_pic_flag has a first value (e.g., 1), gdr_pic_flag has a second value (e.g., 0) (that is, a current picture is an IRAP picture), and vps_independent_layer_flag[GeneralLayerIdx[nuh_layer_id] ] has a first value (e.g., 1), the value of ph_inter_slice_allowed_flag may be set to a second value (e.g., 0). Here, vps_independent_layer_flag[GeneralLayerIdx[nuh_layer_id] ] of a first value (e.g., 1) may specify that a layer having an index GeneralLayerIdx[nuh_layer_id] does not use inter-layer prediction.

In addition, the picture header may further include a syntax element idr_pic_flag specifying whether a current picture is an IDR picture. The semantics and signaling condition of idr_pic_flag were described above with reference to FIG. 8.

In the picture header, reference picture list information ref_pic_lists may be signaled based on a predetermined third condition (1110). Specifically, ref_pic_lists may be signaled only when reference picture list information is present in the picture header (i.e., rpl_info_in_ph_flag==1), syntax elements regarding a reference picture list are present in slices headers of slices having a NAL unit type such as IDR_N_LP or IDR_W_RADL or a current picture is not an IDR picture (i.e., sps_idr_rpl_present_flag==1 or idr_pic_flag==0).

The case of FIG. 11 may be different from the picture header of FIG. 5, in that reference picture list information ref_pic_lists is signaled, based on whether sps_idr_rpl_present_flag has a first value (e.g., 1) or idr_pic_flag has a second value (e.g., 0). That is, when syntax elements regarding a reference picture list of an IDR picture are not present in a slice header (i.e., sps_idr_rpl_present_flag==0) and the current picture is an IDR picture (i.e., idr_pic_flag==1), ref_pic_lists may not be signaled in the picture header. Therefore, a problem that reference picture list information of the IDR picture is unnecessarily signaled in the picture header may be solved.

### Embodiment 5

According to Embodiment 5 of the present disclosure, in a picture header, reference picture list information may be signaled based on whether a current picture is an IDR picture and whether syntax elements regarding a reference picture list of an IDR picture is present in a slice header.

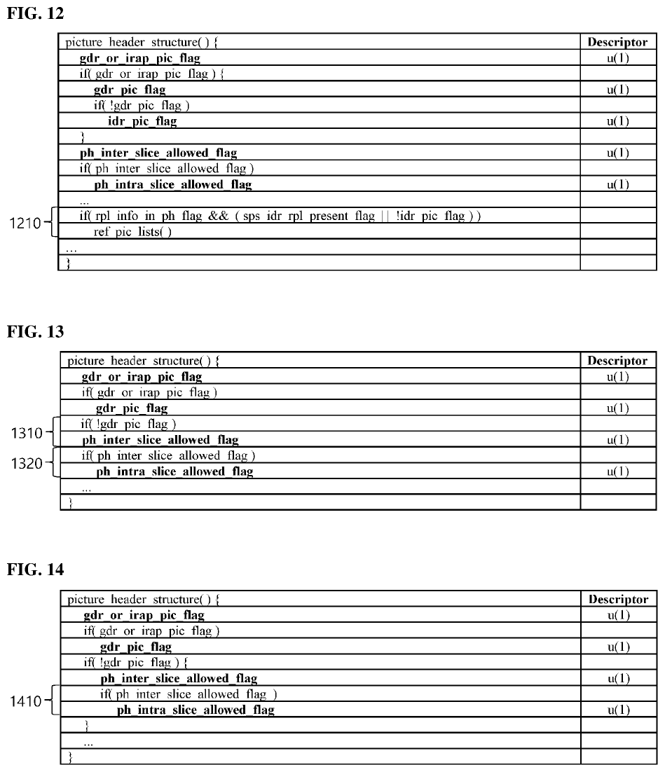

FIG. 12 is a view illustrating a picture header according to an embodiment of the present disclosure.

Referring to FIG. 12, a picture header may include a syntax element gdr_or_irap_pic_flag specifying whether a current picture is a GDR or IRAP picture and a syntax element gdr_pic_flag specifying whether a current picture is a GDR picture. In addition, the picture header may include a syntax element ph_inter_slice_allowed_flag specifying whether one or more slices in a current picture may have an inter slice type (e.g., B slice type or P slice type) and a syntax element ph_intra_slice_allowed_flag specifying whether one or more slices in a current picture may have an intra slice type (e.g., I slice type). The semantics of each of the syntax elements were described above with reference to FIG. 5.

In addition, the picture header may further include a syntax element idr_pic_flag specifying whether a current picture is an IDR picture. idr_pic_flag may be different from idr_pic_flag of FIG. 11, in that it is signaled only when a current picture is not a GDR picture (i.e., gdr_pic_flag==0). That is, when gdr_pic_flag has a first value (e.g., 1), idr_pic_flag may not be signaled. Meanwhile, even if gdr_pic_flag is not signaled, when it is set to a second value (e.g., 0), idr_pic_flag may be signaled.

In the picture header, reference picture list information ref_pic_lists may be signaled based on a predetermined third condition (1210). Specifically, ref_pic_lists may be signaled only when reference picture list information is present in the picture header (i.e., rpl_info_in_ph_flag==1), syntax elements regarding a reference picture list are present in slices headers of slices having a NAL unit type such as IDR_N_LP or IDR_W_RADL or a current picture is not an IDR picture (i.e., sps_idr_rpl_present_flag==1 or idr_pic_flag==0).

The case of FIG. 12 may be different from the picture header of FIG. 5, in that reference picture list information ref_pic_lists is signaled, based on whether sps_idr_rpl_present_flag has a first value (e.g., 1) or idr_pic_flag has a second value (e.g., 0). That is, when syntax elements regarding a reference picture list of an IDR picture are not present in a slice header (i.e., sps_idr_rpl_present_flag==0) and the current picture is an IDR picture (i.e., idr_pic_flag==1), ref_pic_lists may not be signaled in the picture header. Therefore, a problem that reference picture list information of the IDR picture is unnecessarily signaled in the picture header may be solved.

### Embodiment 6

According to Embodiment 6 of the present disclosure, in a picture header, information specifying whether an inter slice is allowed in a current picture may be signaled based on whether a current picture is a GDR picture.

FIG. 13 is a view illustrating a picture header according to an embodiment of the present disclosure.

Referring to FIG. 13, a picture header may include a syntax element gdr_or_irap_pic_flag specifying whether a current picture is a GDR or IRAP picture and a syntax element gdr_pic_flag specifying whether a current picture is a GDR picture. The semantics of each of the syntax elements were described above with reference to FIG. 5.

In addition, the picture header may include a syntax element ph_inter_slice_allowed_flag. ph_inter_slice_allowed_flag may specify whether one or more slices in a current picture may have an inter slice type (e.g., B slice type or P slice type). For example, ph_inter_slice_allowed_flag of a first value (e.g., 1) may specify that one or more coded slices having a B slice type (i.e., slice_type=0) or P slice type (i.e., slice_type=1) may be present in the current picture. In contrast, ph_inter_slice_allowed_flag of a second value (e.g., 0) may specify that all coded slices in the current picture have an I slice type (i.e., slice_type=2).

ph_inter_slice_allowed_flag may be signaled only when the current picture is not a GDR picture (1310). For example, when gdr_pic_flag has a second value (e.g., 0) specifying that the current picture is not a GDR picture, ph_inter_slice_allowed_flag may be signaled. In contrast, when gdr_pic_flag has a first value (e.g., 1) specifying that the current picture is a GDR picture, ph_inter_slice_allowed_flag may not be signaled. When ph_inter_slice_allowed_flag is not signaled, the value of ph_inter_slice_allowed_flag may be inferred as a first value (e.g., 1).

In addition, the picture header may include a syntax element ph_intra_slice_allowed_flag. ph_intra_slice_allowed_flag may specify one or more slices in the current picture may have an intra slice type (e.g., I slice type). For example, ph_intra_slice_allowed_flag of a first value (e.g., 1) may specify that one or more coded slices having an I slice type(i.e., slice_type=2) may be present in the current picture. In contrast, ph_intra_slice_allowed_flag of a second value (e.g., 0) may specify that all coded slices in the current picture have a B slice type (i.e., slice_type=0) or a P slice type (i.e., slice_type=1).

ph_intra_slice_allowed_flag may be signaled only when an inter slice is allowed for the current picture (1720). For example, when ph_inter_slice_allowed_flag has a first value (e.g., 1) specifying that one or more coded slices having a B slice type or a P slice type may be present in the current picture, ph_intra_slice_allowed_flag may be signaled. In contrast, when ph_inter_slice_allowed_flag has a second value (e.g., 0) specifying that all coded slices in the current picture has an I slice type, ph_inter_slice_allowed_flag may not be signaled. When ph_intra_slice_allowed_flag is not signaled, the value of ph_intra_slice_allowed_flag may be inferred as a first value (e.g., 1).

Meanwhile, in another embodiment, ph_intra_slice_allowed_flag may be signaled only when the current picture is not a GDR picture and an inter slice is available for the current picture.

FIG. 14 is a view illustrating a picture header according to another embodiment of the present disclosure. The picture header of FIG. 14 may have the same structure and semantics as the picture header of FIG. 13 except for the signaling condition of ph_intra_slice_allowed_flag. Accordingly, a repeated description thereof will be omitted.

Referring to FIG. 14, in the picture header, ph_intra_slice_allowed_flag may be signaled only when the current picture is not a GDR picture and an inter slice is allowed for the current picture (1410). For example, when gdr_pic_flag has a second value (e.g., 0) specifying that the current picture is not a GDR picture and ph_inter_slice_allowed_flag has a first value (e.g., 1) specifying that one or more coded slices having a B slice type or a P slice type may be present in the current picture, ph_intra_slice_allowed_flag may be signaled. In contrast, when gdr_pic_flag has a first value (e.g., 1) specifying that the current picture is a GDR picture or ph_inter_slice_allowed_flag has a second value (e.g., 0) specifying that all coded slices in the current picture have an I slice type, ph_intra_slice_allowed_flag may not be signaled. When ph_intra_slice_allowed_flag is not signaled, the value of ph_intra_slice_allowed_flag may be inferred as a first value (e.g., 1).

As described above with reference to FIGS. 13 and 14, ph_inter_slice_allowed_flag may be signaled only when the current picture is not a GDR picture. Therefore, a problem that ph_inter_slice_allowed_flag is unnecessarily signaled may be solved, for the GDR picture which may include an inter slice by virtue of the picture attributes.

### Embodiment 7

According to Embodiment 7 of the present disclosure, in a picture header, information specifying whether an inter slice is allowed in a current picture may be signaled based on whether a current layer including the current picture is able to use inter-layer prediction and whether the current picture is an IRAP picture.

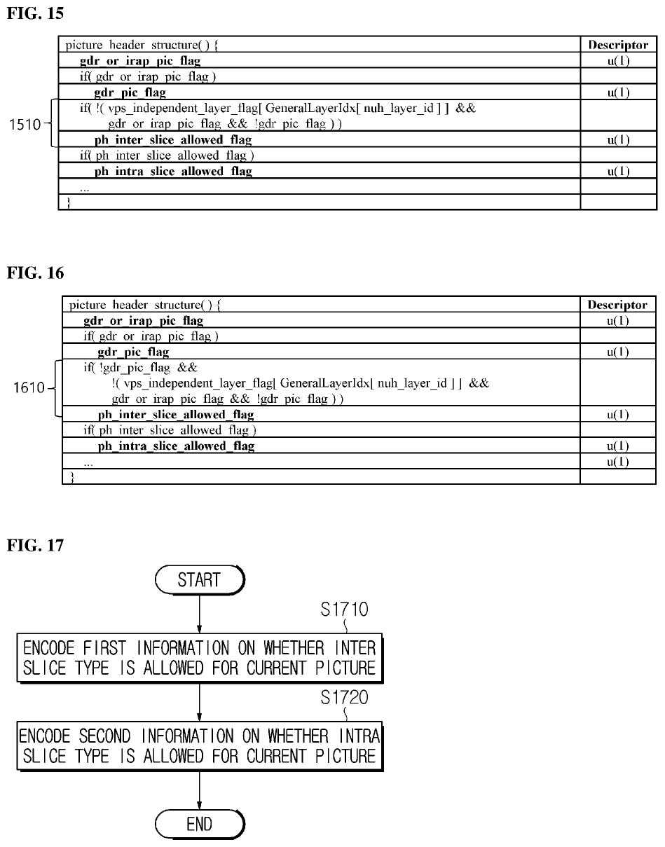

FIG. 15 is a view illustrating a picture header according to an embodiment of the present disclosure.

Referring to FIG. 15, the picture header may include a syntax element gdr_or_irap_pic_flag specifying that a current picture is a GDR or IRAP picture and a syntax element gdr_pic_flag specifying whether a current picture is a GDR picture. The semantics of each of the syntax elements were described above with reference to FIG. 5.

In addition, the picture header may include a syntax element ph_inter_slice_allowed_flag specifying whether an inter slice (e.g., B slice or P slice) is allowed for the current picture. The semantics of ph_inter_slice_allowed_flag were described above with reference to FIG. 13.

ph_inter_slice_allowed_flag may be signaled based on a predetermined fourth condition (1510). Specifically, when vps_independent_layer_flag[GeneralLayerIdx[nuh_layer_id] ] has a second value (e.g., 0) specifying that a current layer including the current picture is able to use inter-layer prediction or gdr_or_irap_pic_flag has a second value (e.g., 0) specifying that the current picture is not a GDR picture and may be an IRAP picture or gdr_pic_flag has a first value (e.g., 1) specifying that the current picture is a GDR picture (i.e., !(vps_independent_layer_flag[GeneralLayerIdx[nuh_layer_id] ] && gdr_or_irap_pic_flag && !gdr_pic_flag)==1), ph_inter_slice_allowed_flag may be signaled. In contrast, when vps_independent_layer_flag[GeneralLayerIdx[nuh_layer_id] ] has a first value (e.g., 1) specifying that the current layer including the current picture is not able to use inter-layer prediction, gdr_or_irap_pic_flag has a first value (e.g., 1) specifying that the current picture is a GDR or IRAP picture, and gdr_pic_flag has a second value (e.g., 0) specifying that the current picture is not a GDR picture (i.e., !(vps_independent_layer_flag[GeneralLayerIdx[nuh_layer_id] ] && gdr_or_irap_pic_flag && !gdr_pic_flag)==0), ph_inter_slice_allowed_flag may not be signaled and may be inferred as a second value (e.g., 0) specifying that an inter slice is not allowed for the current picture. That is, when the current picture is an IRAP picture included in an independent layer which does not use inter-layer prediction, ph_inter_slice_allowed_flag may not be signaled and may be inferred as a second value (e.g., 0) specifying that an inter slice is not allowed for the current picture.

In another embodiment, in the case where ph_inter_slice_allowed_flag is not signaled, when the current picture is a GDR picture (i.e., gdr_or_irap_pic_flag==1 && gdr_pic_flag==1), ph_inter_slice_allowed_flag may be inferred as a first value (e.g., 1) specifying that an inter slice is allowed for the current block. In contrast, when the current picture is not a GDR picture (for example, the current picture is an IRAP picture included in the independent layer (i.e., gdr_or_irap_pic_flag==1 && gdr_pic_flag==0 && vps_independent_layer_flag[GeneralLayerIdx[nuh_layer_id] ]==1)), ph_inter_slice_allowed_flag may be inferred as a second value (e.g., 0) specifying that an inter slice is not allowed for the current picture.

Meanwhile, in an embodiment, when gdr_or_irap_pic_flag has a first value (e.g., 1), gdr_pic_flag has a second value (e.g., 0) (that is, the current picture is an IRAP picture), and vps_independent_layer_flag[GeneralLayerIdx[nuh_layer_id]] has a first value (e.g., 1), the value of ph_inter_slice_allowed_flag may be set to a second value (e.g., 0). Here, vps_independent_layer_flag[GeneralLayerIdx[nuh_layer_id] ] of a first value (e.g., 1) may specify that a layer having an index GeneralLayerIdx[nuh_layer_id] does not use inter-layer prediction.

As described above with reference to FIG. 15, when the current picture belongs to an independent layer which does not use inter-layer prediction and the current picture is only an IRAP picture (i.e., !(vps_independent_layer_flag[GeneralLayerIdx[nuh_layer_id] ] && gdr_or_irap_pic_flag && !gdr_pic_flag)==0), ph_inter_slice_allowed_flag may not be signaled. Therefore, a problem that ph_inter_slice_allowed_flag is unnecessarily signaled may be solved, for the IRAP picture which may include an intra slice by virtue of the picture attributes.

### Embodiment 8

According to Embodiment 8 of the present disclosure, in a picture header, information specifying whether an inter slice is allowed in a current picture may be signaled based on whether the current picture is a GDR picture, whether a current layer including the current picture is able to use inter-layer prediction and whether the current picture is an IRAP picture.

FIG. 16 is a view illustrating a picture header according to an embodiment of the present disclosure.

Referring to FIG. 16, the picture header may include a syntax element gdr_or_irap_pic_flag specifying that a current picture is a GDR or IRAP picture and a syntax element gdr_pic_flag specifying whether a current picture is a GDR picture. The semantics of each of the syntax elements were described above with reference to FIG. 5.

In addition, the picture header may include a syntax element ph_inter_slice_allowed_flag specifying whether an inter slice (e.g., B slice or P slice) is allowed for the current picture. The semantics of ph_inter_slice_allowed_flag were described above with reference to FIG. 13.

ph_inter_slice_allowed_flag may be signaled based on a predetermined fifth condition (1610). In this case, the fifth condition may include a (5-1)-th condition and a (5-2)-th condition. Specifically, the (5-1)-th condition may mean that gdr_pic_flag has a second value (e.g., 0) specifying that the current picture is not a GDR picture (i.e., !(gdr_pic_flag)==1). In addition, the (5-2)-th condition may mean that vps_independent_layer_flag[GeneralLayerIdx[nuh_layer_id] ] has a second value (e.g., 0) specifying that a current layer including the current picture is able to use inter-layer prediction or gdr_or_irap_pic_flag has a second value (e.g., 0) specifying that the current picture is not a GDR picture and may be an IRAP picture or gdr_pic_flag has a first value (e.g., 1) specifying that the current picture is a GDR picture (i.e., !(vps_independent_layer_flag[GeneralLayerIdx[nuh_layer_id] ] && gdr_or_irap_pic_flag && !gdr_pic_flag)==1). When both the (5-1)-th condition and the (5-2)-th condition are true, ph_inter_slice_allowed_flag may be signaled. In contrast, when at least one of the (5-1)-th condition or the (5-2)-th condition is false, ph_inter_slice_allowed_flag may not be signaled and may be inferred as a second value (e.g., 0) specifying that an inter slice is not allowed for the current picture. That is, when the current picture is a GDR picture or the current picture is an IRAP picture included in an independent layer which does not use inter-layer prediction, ph_inter_slice_allowed_flag may not be signaled and may be inferred as a second value (e.g., 0) specifying that an inter slice is not allowed for the current picture.

In another embodiment, in the case where ph_inter_slice_allowed_flag is not signaled, when the current picture is a GDR picture (i.e., gdr_or_irap_pic_flag==1 && gdr_pic_flag==1), ph_inter_slice_allowed_flag may be inferred as a first value (e.g., 1) specifying that an inter slice is allowed for the current block. In contrast, when the current picture is not a GDR picture (for example, the current picture is an IRAP picture included in the independent layer (i.e., gdr_or_irap_pic_flag==1 && gdr_pic_flag==0 && vps_independent_layer_flag[GeneralLayerIdx[nuh_layer_id] ]==1)), ph_inter_slice_allowed_flag may be inferred as a second value (e.g., 0) specifying that an inter slice is not allowed for the current picture.

Meanwhile, in an embodiment, when gdr_or_irap_pic_flag has a first value (e.g., 1), gdr_pic_flag has a second value (e.g., 0) (that is, the current picture is an IRAP picture), and vps_independent_layer_flag[GeneralLayerIdx[nuh_layer_id]] has a first value (e.g., 1), the value of ph_inter_slice_allowed_flag may be set to a second value (e.g., 0). Here, vps_independent_layer_flag[GeneralLayerIdx[nuh_layer_id] ] of a first value (e.g., 1) may specify that a layer having an index GeneralLayerIdx[nuh_layer_id] does not use inter-layer prediction.

As described above with reference to FIG. 16, when the current picture is a GDR picture (i.e., !(gdr_pic_flag)==0) or the current picture belongs to an independent layer which does not use inter-layer prediction, and the current picture is only an IRAP picture (i.e., !(vps_independent_layer_flag[GeneralLayerIdx[nuh_layer_id] ] && gdr_or_irap_pic_flag && !gdr_pic_flag)==0), ph_inter_slice_allowed_flag may not be signaled. Therefore, a problem that ph_inter_slice_allowed_flag is unnecessarily signaled may be solved, for the IRAP picture which may include an intra slice and a GDR picture which may include an inter slice by virtue of the picture attributes.

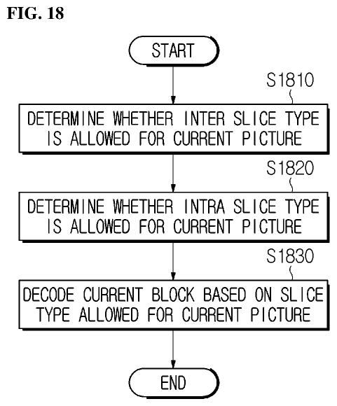

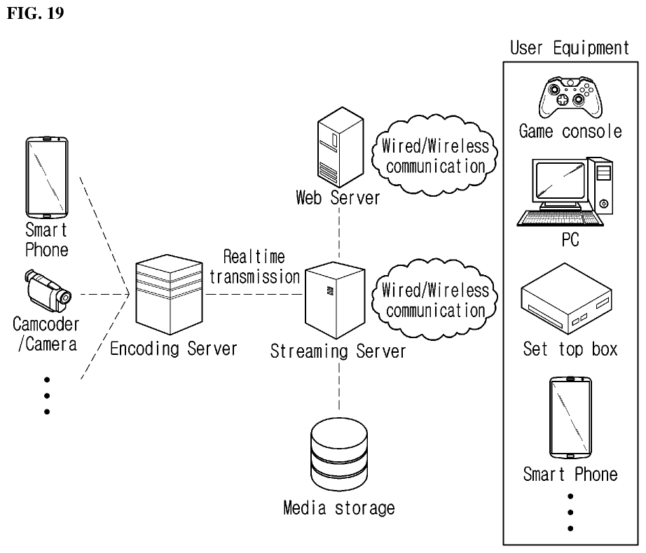

Hereinafter, an image encoding/decoding method according to an embodiment of the present disclosure will be described in detail with reference to FIGS. 17 and 18.

FIG. 17 is a flowchart illustrating an image encoding method according to an embodiment of the present disclosure. The image encoding method of FIG. 17 may be performed by the image encoding apparatus of FIG. 2.

Referring to FIG. 17, the image encoding apparatus may encode first information on whether an inter slice type is allowed for a current picture including a current block (S1710). The first information may be, for example, ph_inter_slice_allowed_flag described above with reference to FIGS. 7 to 16. In an example, the first information may be determined based on a slice type of slices in the current picture. For example, when one or more slices in the current picture have a B slice type or P slice type, the first information may have a first value (e.g., 1) specifying that an inter slice type is allowed for the current picture. In contrast, when all slices in the current picture have an I slice type, the first information may have a second value (e.g., 0) specifying that an inter slice type is not allowed for the current picture.

In an embodiment, whether the inter slice type is allowed for the current picture may be determined based on a picture type of the current picture and whether a current layer including the current picture is able to use inter-layer prediction. For example, when the current picture has the same picture type as an IRAP (Intra Random Access Point) picture and the current layer including the current picture does not use inter-layer prediction, the inter slice type may not be allowed for the current picture. Alternatively, when the current picture has the same picture type as a GDR (Gradual Decoding Refresh) picture, the inter slice type may be allowed for the current picture. In addition, in this case, encoding of the first information may be skipped.

Information on the picture type of the current picture may be encoded in a picture header. The information on the picture type of the current picture may include third information on whether the current picture has the same picture type as a GDR (Gradual Decoding Refresh) or IRAP (Intra Random Access Point) picture and fourth information on whether the current picture has the same picture type as a GDR picture. The third information and the fourth information may be, for example, gdr_or_irap_pic_flag and gdr_pic_flag described above with reference to FIGS. 7 to 16. When the current picture has the same picture type as an IRAP picture, the third information may have a first value (e.g., 1) specifying that the current picture has the same picture type as a GDR or IRAP picture. In addition, the fourth information may have a second value (e.g., 0) specifying that the current picture has a picture type different from that of a GDR picture.

Meanwhile, fifth information (e.g., vps_independent_layer_flag[GeneralLayerIdx[nuh_layer_id]] on whether the current layer is able to use inter-layer prediction (that is, whether the current layer is an independent layer in a multi-layer structure) may be encoded in a video parameter set. When the fifth information has a first value (e.g., 1), the current layer is not able to use inter-layer prediction. In contrast, when the fifth information has a second value (e.g., 0), the current layer is able to use inter-layer prediction.

Based on the inter slice type being allowed for the current picture, the image encoding apparatus may encode second information on whether an intra slice type is allowed for the current picture (S1720). The second information may be, for example, ph_intra_slice_allowed_flag described above with reference to FIGS. 7 to 16. The second information may be determined based on the slice type of the slices in the current picture, similarly to the first information. For example, when one or more slices in the current picture have an I slice type, the second information may have a first value (e.g., 1) specifying that an intra slice type is allowed for the current picture. In contrast, when all slices in the current picture have a B slice type or P slice type, the second information may have a second value (e.g., 0) specifying that the intra slice type is not allowed for the current picture. The second information may be encoded/signaled in the picture header along with the first information. Meanwhile, in the present disclosure, the first information and the second information may be referred to as available slice type information.

FIG. 18 is a flowchart illustrating an image decoding method according to an embodiment of the present disclosure. The image decoding method of FIG. 18 may be performed by the image decoding apparatus of FIG. 3.

Referring to FIG. 18, the image decoding apparatus may determine whether an inter slice type is allowed for a current picture including a current block (S1810).

Whether the inter lice type is allowed for the current picture may be determined based on first information (e.g., ph_inter_slice_allowed_flag) obtained from a picture header. For example, when the first information has a first value (e.g., 1), the inter slice type may be allowed for the current picture. In contrast, when the second information has a second value (e.g., 0), the inter slice type may not be allowed for the current picture.

In an embodiment, whether the inter slice type is allowed for the current picture may be determined based on a picture type of the current picture and whether a current layer including the current picture is able to use inter-layer prediction. For example, based on the current picture having the same picture type as an IRAP (Intra Random Access Point) picture and the current layer doing not use inter-layer prediction, the inter slice type may not be allowed for the current picture. Alternatively, when the current picture has the same picture type as a GDR (Gradual Decoding Refresh) picture, the inter slice type may be allowed for the current picture. In addition, in this case, parsing of the first information may be skipped.

The picture type of the current picture may be determined based on third information on whether the current picture has the same picture type as a GDR (Gradual Decoding Refresh) or an IRAP (Intra Random Access Point) picture and fourth information on whether the current picture has the same picture type as a GDR picture. The third information and the fourth information may be, for example, gdr_or_irap_pic_flag and gdr_pic_flag described above with reference to FIGS. 7 to 16. When the third information specifies that the current picture has the same picture type as a GDR or IRAP picture and the fourth information specifies that the current picture has a picture type different from that of a GDR picture, the picture type of the current picture may be determined to be the same picture type as an IRAP picture.

Meanwhile, whether the current layer is able to use inter-layer prediction (that is, whether the current layer is an independent layer in a multi-layer structure) may be determined based on fifth information obtained from a video parameter set. For example, when the fifth information has a first value (e.g., 1), the current layer is not able to use inter-layer prediction. In contrast, when the fifth information has a second value (e.g., 0), the current layer is able to use inter-layer prediction.

Based on the inter slice type being allowed for the current picture, the image decoding apparatus may determine whether an intra slice type is allowed for the current picture (S1820).

Whether the intra slice type is allowed for the current picture may be determined based on second information (e.g., ph_intra_slice_allowed_flag) obtained from a picture header. For example, when the second information has a first value (e.g., 1), the intra slice type may be allowed for the current picture. In contrast, when the second information has a second value (e.g., 0), the intra slice type may not be allowed for the current picture. Meanwhile, in the present disclosure, the first information and the second information may be referred to as available slice type information.

In addition, the image decoding apparatus may decode the current block based on a slice type allowed for the current picture (S1830). For example, the image decoding apparatus may determine a slice type of slices in the current picture based on the slice type allowed for the current picture. When the current block is included in a slice having an inter slice type, the image decoding apparatus may decode the current block by performing inter prediction. In contrast, when the current block is included in a slice having an intra slice type, the image decoding apparatus may decode the current block by performing intra prediction.

According to the image encoding/decoding method according to an embodiment of the present disclosure, when the current picture belongs to an independent layer which does not use inter-layer prediction and the current picture is only an IRAP picture, the inter slice type may not be allowed for the current picture. Therefore, in an encoding stage, since it is not necessary to signal information (e.g., ph_inter_slice_allowed_flag) specifying whether the inter slice type is allowed for the current block, signaling overhead may be reduced and encoding efficiency may be improved. In addition, in a decoding stage, since it is not necessary to parse information (e.g., ph_inter_slice_allowed_flag) specifying whether the inter slice type is not allowed for the current block, computational complexity may be reduced and decoding efficiency may be improved.

The name of the syntax element described in the present disclosure may include information on a position where the corresponding syntax element is signaled. For example, a syntax element starting with “sps_” may mean that the corresponding syntax element is signaled in a sequence parameter set (SPS). In addition, a syntax element starting with “pps_”, “ph_”, “sh_” may mean that the corresponding syntax element is signaled in a picture parameter set (PPS), a picture header and a slice header, respectively.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

FIG. 16 is a view illustrating a content streaming system, to which an embodiment of the present disclosure is applicable.

As shown in FIG. 16, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
determining whether an inter slice type is allowed for a current picture including a current block;
determining whether an intra slice type is allowed for the current picture, based on the inter slice type being allowed for the current picture; and
decoding the current block based on a slice type allowed for the current picture,
wherein whether the inter slice type is allowed for the current picture is determined based on a picture type of the current picture and whether a current layer including the current picture is an independent layer to be decoded without reference to other layers.

2. The image decoding method of claim 1,
wherein whether the inter slice type is allowed for the current picture is determined based on first information obtained from a picture header, and
wherein whether the intra slice type is allowed for the current picture is determined based on second information obtained from the picture header.

3. The image decoding method of claim 1, wherein, based on the current picture having the same picture type as an intra random access point (IRAP) picture and the current layer being the independent layer, the inter slice type is not allowed for the current picture.

4. The image decoding method of claim 1, wherein the picture type of the current picture is determined based on third information on whether the current picture has the same picture type as a gradual decoding refresh (GDR) or intra random access point (IRAP) picture and fourth information on whether the current picture has the same picture type as the GDR picture.

5. The image decoding method of claim 4,
wherein, based on the third information specifying that the current picture has the same picture type as the GDR or IRAP picture and the fourth information specifying that the current picture has a picture type different from that of the GDR picture,
the picture type of the current picture is determined to be the same picture type as the IRAP picture.

6. The image decoding method of claim 1, wherein whether the current layer is the independent layer is determined based on fifth information obtained from a video parameter set.

7. (canceled)

8. An image encoding method performed by an image encoding apparatus, the image encoding method comprising:
encoding first information on whether an inter slice type is allowed for a current picture including a current block; and
encoding second information on whether an intra slice type is allowed for the current picture, based on the inter slice type being allowed for the current picture,
wherein whether the inter slice type is allowed for the current picture is determined based on a picture type of the current picture and whether a current layer including the current picture is an independent layer to be decoded without reference to other layers.

9. The image encoding method of claim 8, wherein, based on the current picture having the same picture type as an intra random access point (IRAP) picture and the current layer being the independent layer, the inter slice type is not allowed for the current picture.

10. The image encoding method of claim 8, wherein, based on the current picture having the same picture type as a gradual decoding refresh (GDR) picture, the inter slice type is allowed for the current picture and encoding of the first information is skipped.

11. The image encoding method of claim 8, wherein information on the picture type of the current picture is encoded in a picture header.

12. The image encoding method of claim 11, wherein the information on the picture type of the current picture includes third information on whether the current picture has the same picture type as a gradual decoding refresh (GDR) or intra random access point (IRAP) picture and fourth information on whether the current picture has the same picture type as the GDR picture.

13. The image encoding method of claim 12, wherein, based on the current picture having the same picture type as the IRAP picture, the third information has a first value specifying that the current picture has the same picture type as the GDR or IRAP picture and the fourth information has a second value specifying that the current picture has a picture type different from that of the GDR picture.

14. The image encoding method of claim 8, wherein fifth information on whether the current layer is the independent layer is encoded in a video parameter set.

15. A computer-readable recording medium storing a bitstream generated by the image encoding method of claim 8.

16. A method of transmitting a bitstream generated by an image encoding method, the image encoding method comprising:
encoding first information on whether an inter slice type is allowed for a current picture including a current block; and
encoding second information on whether an intra slice type is allowed for the current picture, based on the inter slice type being allowed for the current picture,
wherein whether the inter slice type is allowed for the current picture is determined based on a picture type of the current picture and whether a current layer including the current picture is an independent layer to be decoded without reference to other layers.
